(19) United States
(12) Patent Application Publication
(10) Pub. No.: US 2008/0067247 A1
(43) Pub. Date: Mar. 20, 2008

(54) Biometric authentication card and method of fabrication thereof

(76) Inventors: Travis M. McGregor, San Francisco, CA (US); Christopher M. McGregor, San Francisco, CA (US); Gregory M. McGregor, Walnut Creek, CA (US); John T. Gill, Stanford, CA (US); G. Frederick Renner, Dublin, OH (US); George K. Lund, Castro Valley, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/901,093

(22) Filed: Sep. 14, 2007

Related U.S. Application Data
(60) Provisional application No. 60/844,735, filed on Sep. 15, 2006.

(51) Int. Cl. G06K 5/00; G06K 7/00

(52) U.S. Cl. 235/439; 235/380

(57) ABSTRACT

A credit card size authentication card is manufactured using innovative sensor technology, processor technology, power generation and storage, panel display and integration technology. The front of the card has a data display and an exposed, biometric sensor. Internally the card has one or more flex boards that carry low profile, surface-mounted electronic components including a processor that provides the control functions and mathematical calculations to generate a series of random personal identification numbers (PINs) in the display. The random PINs are derived from a biometric seed number obtained during initialization of the card by a discrete user. The electronic circuitry controlling and interconnecting the processor, the sensor and the display is powered by a power system including a thin film battery, a thin film power generator and a low profile power regulator. The thin film power generator preferably comprises a thin film solar collector or RF antenna circuit for energy harvesting. The thin film power generator and thin film battery are layered and preferably docked to the flex board carrying the primary components of the card. The card panels are formed from panel sheets which may be reverse printed with the top or front panel sheets having clear or translucent windows for the data display and solar collectors and die cut to expose the sensor elements.

### CROSS-REFERENCE TO RELATED APPLICATIONS

This application claims priority from U.S. Provisional Patent Application Ser. No. 60/844,735 filed Sep. 15, 2006 which is a continuation-in-part of pending U.S. application Ser. No. 10/940,920 filed on Sep. 14, 2004 which is a divisional application of Ser. No. 09/843,572 filed on Apr. 26, 2001 and now issued U.S. Pat. No. 6,816,058.

### BACKGROUND OF THE INVENTION

1. Field of the Invention

The present invention relates to a biometric authentication card disclosed as a preferred embodiment in U.S. Pat. No. 6,816,058 and a preferred method of fabrication. The biometric authentication card is designed to a form factor that is an ISO standard for commercial cards such as the common credit card or debit card, and includes a commercially standard interface mechanism, such as a magnetic memory strip or smart chip. In this manner the authentication card may be used in most of the existing processing equipment for commercial transactions. Additionally, because the authentication card is initialized biometrically for a particular user, the card has application as an identification card to authenticate the cardholder as the individual who initialized the card.

2. Background Art

The complexities of fabricating an authentication card the size of a credit card that receives a user input, processes the input and generates an output cannot be overestimated. In order to physically accommodate the components that are required to make the card operational over a reasonable lifespan, at least six technologies, all fairly new as of the time of this filing, must be integrated and implemented.

### Sensor Technology

Although there are numerous biometric sensor technologies that will find applicability to a biometric card of the type described, fingerprint recognition technology is one that can currently be adapted to the size restrictions contemplated. New methods of mounting and exposing the sensors are disclosed.

### Processor Technology

Advanced miniaturized processors with low power demands are available and can be modified to reduce the component profile for use on a flex board with a combined height that is within the maximum acceptable card thickness.

### Power Generation Technology

Recent advances in flexible solar collectors and radio frequency (RF) energy harvesting have enabled on-card power generation for maintenance of the system.

### Power Storage Technology

Prototype flexible film batteries are available for integration and coupling with collectors for low profile power assemblies.

### Thin Display Technology

Experimental thin LCD's and low profile custom LED's for visual read-out of generated verification data are utilized in the disclosed embodiment.

### Panel Integration Technology

Advanced card panel cutting, positioning and injection processes are used to produce an integral monolithic structure.

In addition to the advanced technologies that must be tailored to the fabrication of a workable production card having the attributes required, additional techniques have been devised to construct a card with the described capabilities within a reasonable cost.

In summary, the method of constructing a biometric authentication card of the complexity required to meet the security demands of the world's premier financial institutions transcends simple engineering and requires the inventive collaboration of those of extraordinary skill in the arts of identity verification and authentication, and design and fabrication.

### SUMMARY OF THE INVENTION

The preferred embodiment described is not set forth to limit this invention, but to provide a clear example of an operative embodiment that demonstrates the method of fabrication and manufacture of the authentication card and defines the physical card resulting from such fabrication and manufacture. The authentication card has a form factor that is similar to a common credit or debit card with a front surface marked with the necessary account information including account number and expiration date when the card is utilized as a commercial transaction device. In general, the raised or relief of the account information is omitted, in part to avoid the application of excessive forces applied with legacy manual receipt equipment. The card is flexible within limits and has a back surface with a magnetic strip located longitudinally across the card at a location for reading by conventional card read equipment during a card swipe operation.

Uniquely, the front of the card has a data display and an exposed, biometric sensor. The exposure of the sensor in the preferred embodiment is relatively complete, but may be limited, for example, as in a permeable film for DNA detection or lens for pattern recognition, or for further security could be hidden from the view of the user, thereby triggering an alarm feature if the user fails to utilize the sensor as intended. Internally the card has one or more flex boards that carry low profile, surface-mounted electronic components including a thin processor that provides the control functions and mathematical calculations to generate a series of random personal identification numbers (PINs) in the data display. The random PINs are derived from a biometric seed number obtained during initialization of the card by the discrete user. The seed number may be encrypted and passed directly or by an encrypted communication to the authentication center where the series of random PINS can be duplicated for comparison and validation. Typically, on comparison, correlation and verification as a transaction valid PIN, the transaction, such as a merchandise purchase, is authorized and a return receipt is generated. A similar process is used where an event, such as entry to a secure area, is triggered by recognition of a valid single use code.

The electronic circuitry controlling and interconnecting a processor, the sensor and a display is powered by a power system including a thin film battery, a thin film power generator and a low profile power regulator. The thin film power generator preferably comprises a thin film solar collector or RF antenna circuit for energy harvesting. The thin film power generator and thin film battery are layered and preferably docked to the flex board carrying the primary components of the card. The thin film battery and thin film power generator may form a laminated composite, particularly where structural advantages are obtained.

The card panels are formed from panel sheets which may be reverse printed with the top or front panel sheets having clear or translucent windows for the data displays and solar collectors (if used) and die cut for the slots to expose the sensor elements (where necessary). The panel sheets are located in an injection press with the sets of card electronics positioned between the card sheets and the internal spaces and voids are injected with a fill fluid that cures to form a compatible composition for a flexible card while providing a cushion for the internal electronics. The composite panel sheets are die cut to form discrete cards with the look and feel of conventional credit and debit cards.

At a secure location the discrete cards are circuit tested, optionally loaded with additional software, run through a software test routine and audited for shipment and issuance. These and other features of the biometric authentication card are described in greater detail below in the detailed description of the preferred embodiments. Because this description relates in part to a biometric authentication card embodiment disclosed in now issued U.S. Pat. No. 6,816,058, that patent disclosure is hereby incorporated herein by reference as if fully set forth herein.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a perspective view of a biometric authentication card fabricated according to the method described herein;

FIG. 2 is a plan view of the underside of the card shown in FIG. 1;

FIG. 3 is an electrical schematic diagram in block form showing the general arrangement of electrical components in the card of FIGS. 1 and 2;

FIG. 4 is schematic exploded view of the card panels and internal components in an injection press;

FIG. 5 is a partial view of an IC chip directly wired to a flex board;

FIG. 6 is an enlarged partial exploded view of a biometric sensor grounding and sealing system;

FIG. 7 is an alternate embodiment of a biometric authentication card fabricated according to the described method; and

FIG. 8 is a schematic illustration of the data display of the alternate embodiment and a key fabrication step for forming a thin LCD display.

### DETAILED DESCRIPTION OF THE PREFERRED EMBODIMENTS

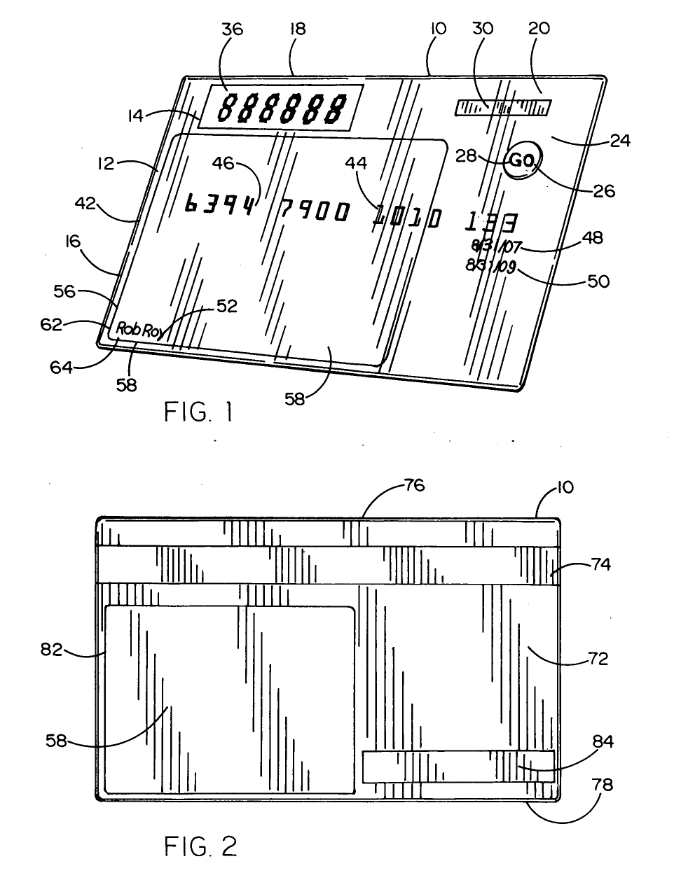

Referring to FIG. 1, a biometric card, the product of the process for fabricating a biometric authentication card, is designated generally by the reference numeral 10. The biometric card 10 is shown in prospective view with a front surface 12 having an upper portion 14, a lower portion 16, a left part 18 and a right part 20. The rough division of the card surface into quadrants is for purposes of convenience and is not to limit the invention but to aid in the description of the card layout, particularly as it relates to the best use of the limited card real estate and to the ergonomic aspects of operating the card.

The upper portion 14 of the card when oriented in the classic landscape mode, includes the input and output controls 24. The basic I/O controls include an activation button 26, which brings the card alive by powering up and initiating a startup routine. Because the card is a relatively low cost item, the default layout is designed to principally accommodate a right-handed individual. The card 10 is most conveniently grasped in the left hand with manual input accomplished by the right hand, and in particular by the right thumb. The thumb comfortably depresses the activation button 26 located in the right part 18 of the upper portion 14 of the card with the right forefinger providing backing and support for the applied pressure. The activation button is preferably defined by a graphic marking 28 and has a depressed surface elevation to minimize inadvertent activation when, for example, the card 10 is stored in a user's wallet.

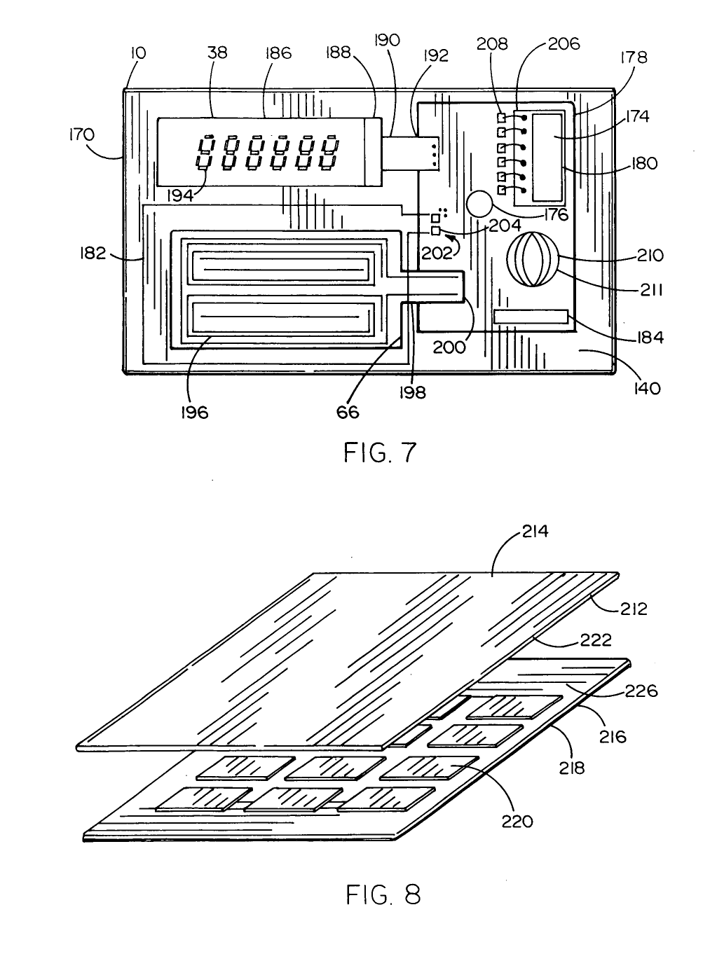

Near the activation button 26 is a biometric sensor 30. The biometric sensor 30 is a finger swipe bar 32 and is located above the activation button 26. The finger swipe bar 32 is shown in FIG. 1 oriented horizontally to provide for a downward sweep of the user's thumb when first initializing or personalizing the card 10 and later using the card system to generate a transaction discrete PIN. The orientation of the finger swipe bar 32 is in part dictated by the limited real estate within the card and may alternately be oriented in the vertical, particularly when the electronic components are integrated on a space-saving IC or ASIC as shown in the partial schematic of FIG. 7. This alternate orientation permits a convenient thumb or finger swipe off the end of the card avoiding inadvertent contact with the activation button 26.

In the left part 18 of the upper portion 14 of the front surface 12 is an output device 34 in the form of a data display 36. The data display 36 is primarily for display of the generated PIN resulting from a successful thumb swipe. It is to be understood that the card 10 can incorporate other output controls such as the LED status light in the FIG. 7 embodiment. However, in keeping the system simple, the display 36 can provide such additional functions by blinking or messaging within the character limitations of the display. The data display is a six character numerical LED which is sufficient to handle most levels of security contemplated. Although three and four character displays can be used for low-level transactions with existing commercial card protocols for static pin and card back numbers, the security is relatively weak and at least a minimum of five characters is preferred.

Alternately, a thin film LCD display 38 is used as shown in FIG. 7. However, to maintain the minimum profile required of a credit-card-like authentication device, an LCD display should be specially fabricated in the manner hereafter described with reference to FIG. 8.

In the central area 42 between the upper portion 14 and the lower portion 16, a region of the card 10 is used for information relevant to the application of the card 10. For example, the typical account information is presented by printed markings 44, including account number 46, issue date 48 and expiration date 50. In addition the markings 44 may include the name 52 of the card user whose biometric data the card 10 employs to generate the PIN, or an entity related to the card such as the issuer or sponsor. It is to be understood that the devised authentication card 10 has many applications for verifying the user and is not dependent on the actual identity of the user. When used as an entry card keying the card 10 to the initializer of the card, no information need be presented in the central area 42. Also, it is to be understood that the use of the term PIN for Personal Identification Number includes a number that is simply a code number that, for example, is used for an entry code or access code to a secure area such as a room, safe, or computer.

The lower portion 16 of the front surface 12 of the card 10 has a power generator 56 that in the embodiment of FIG. 1 is a solar collector 58. The solar collector 58 is preferably in the form of a thin film collector 60 that has an active area 62 located under a protective transparent window 64. Alternately, the power generator 56 comprises an RF antenna 66 as schematically illustrated in FIG. 7. Notably, when the power generator 56 is an RF antenna 66, the front surface 12 need not include a transparent window 64 and can be used for other printed markings 68 as desired.

Although other I/O controls 24 and informational markings 44 could be added to the front surface 12 of the card 10, in keeping it simple, the fewer controls the better and the fewer markings, the less likelihood of confusion.

Referring now to FIG. 2, the card 10 includes a back surface 72 that preferably includes a magnetic strip 74, particularly when the application of the card 10 is for a debit or credit card. The magnetic strip 74 is located adjacent the top edge 76 or bottom edge 78 at the appropriate location for use in legacy card swipe equipment. The back surface 72 is also available for markings 78, such as printed markings including instructions, logos and other indicia common in the commercial card trade. Optionally, the back surface 72 may include a window 82 for the solar collector 58, however, it is presumed that the front surface 12 is more likely to be exposed to the light. Where necessary, a textured signature area 84 is provided for inclusion of the user's authorized signature and a printed duplicate of the account number 46 is provided for convenience.

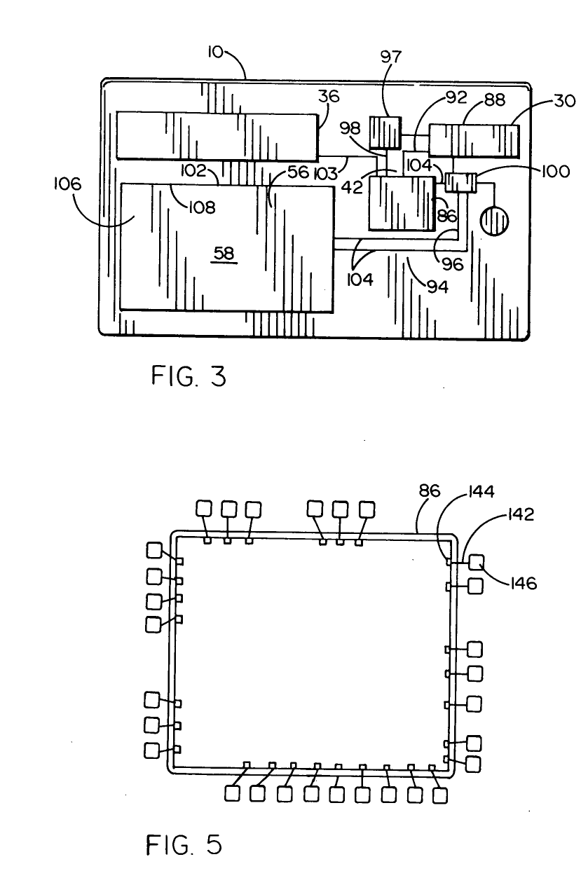

Referring to FIG. 3, a schematic diagram of the electronic circuit 85 is shown in block form to illustrate the primary components and their general location within the card 10. In the central area 42 is located the processor 86. The processor is an ASIC that includes internal memory and adopts the ARM architecture for system operations. The processor 86 is required to be not only power efficient but sufficiently powerful to process the input data and perform the necessary mathematical calculations to generate the biometric seed number and the required encryptions for the one use code.

A processor utilizing the ARM or MIPS architecture satisfies the power management, control and calculations required for the functions and operations described. Other processor architectures could be utilized. In the right part 20 of the upper portion 14 of the card is located the wafer sensor chip 88 for the biometric sensor 30. The processor 86 and wafer sensor chip 88 are interconnected by an electronic circuit 92 and are both connected to a power source 94 by electronic circuit 96. Between the processor 86 and wafer sensor chip is a clocking chip 97 that is connected to the processor 86 by circuit 98 for pulse timing of the processor operations. The timing circuit may also be connected to the sensor chip 88 when a direct timing signal is required for sensor operation.

The power source 94 includes a power regulator 100, the power generator 56, a power storage device 102 and a power control circuit 104. The power regulator 100 manages the voltage and current supply to the processor 86 and other components as necessary and with the power control circuit 104, regulates the charging of the power storage device 102 by the power generator 56. The power storage device 102 is preferably a thin film battery assembly 106. The power generator 56, in the embodiment of FIG. 1, is the thin film solar collector 58. The data display 36 is connected to the processor 86 by circuit 103 and is powered by the processor 86 through its connection with the power source 94. Optionally, certain functions of the data display 36 may be powered by the sensor chip 88 through its connection with the power source 94, for example the signal to indicate a successful or unsuccessful finger swipe. It is to be understood that the processor 86 contains the key codes and operations protocols, and thereby, ultimately controls the operations of the components, including the biometric sensor 30 and the visual display 36. Therefore, the power source 94 may include a power control circuit 104 that connects to various components and is regulated by the processor.

The requirements of the visual display 36 are minimal. As noted, the general utility of the authentication card 10 is for validation that the holder who was issued the card and is responsible for the transactions enabled by the card, is the person who is using the card. The environment of use therefore becomes important. The card is subject to all ranges of light, since the card may be used in places with poor lighting including dimly lit restaurants. Therefore, the display must emit light to be effective.

At the high end, is the high-resolution display 38, shown in FIG. 7. The display 38 may comprise a plasma, backlit LCD, micro LED composite, or other high pixel visual device. However, the simple crystal diode numeric display of FIG. 1 is all that is required to generate the transaction code number. The LED numeric display 36 in FIG. 1 is a six-digit display that is simple to program, uses minimal processing power, is easy to read and is familiar to all. The LED display 36 has a plurality of discrete miniature light emitting diodes 112 that are carried on a flexible substrate that is an etched flex board 114. The display 36 includes an overlay mask 116 with cutouts 118 to accommodate the individual diodes 112. The flex board 114 carries the processor 86, the sensor 30, the power regulator 100, the clocking chip 97 and the remaining resistors, capacitors and electronic elements that are part of the overall electronic circuit 85. The flex board 114 has electronic circuitry on both sides of the board in order to route the circuits that interconnect the components that make up the system.

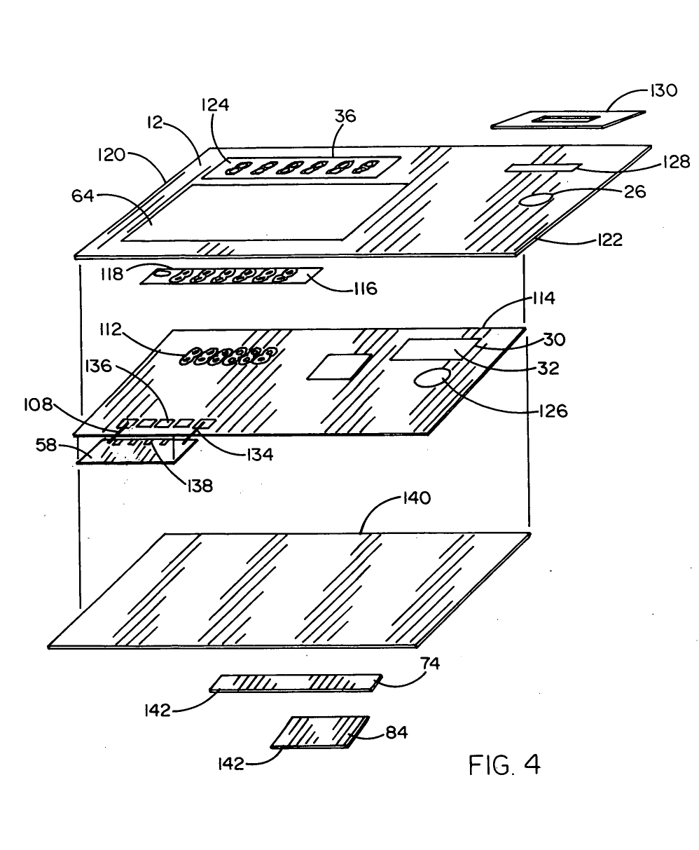

Referring to the exploded view of FIG. 4, the card 10 has a top panel 120 that forms the front surface 12 of a card when cut from a panel sheet (not shown). The panel sheet is pre-printed on the reverse or underside 122 leaving the clear window 64 for the solar collector 58 and a set of translucent “lenses” 124 for the diodes 112. The diodes 112 emit light through cutouts 118 that are provided in an overlay mask 116 over the flex board 114 for the display 36. The preprinting of the underside of the top panel 120 may include several printed layers including an electrically conductive area under the activation button 26 that coacts with a circuit pad 126 for use in switching on the authentication card 10 before use. In addition to printing, the panel sheet is prepared by die cutting a sensor aperture 128 for the finger swipe bar 32 of the biometric sensor 30 and applying a conductive grounding frame 130 around the aperture 128 to prevent static electricity from damaging the sensitive sensor.

The flex board 114 under the top panel 120 has large terminal pads 134 and contact pads 136 for interconnecting the solar collector 58 and battery assembly 108 which are docked to the flex board 114 by conductor wires 132. The battery assembly 108 comprises a series of discrete flexible film batteries 138, here three in number.

Under the flex board 114 is the bottom panel 140 which is similarly preprinted with the information noted with reference to FIG. 2. The bottom panel 140 has the magnetic strip 74 and signature area 84 applied as thin film tape segments 142. During fabrication, prior to cutting the panel sheets into discrete cards, the sheet carrying the top panels is held in an injection cavity on alignment pegs. The flex board assemblies 144, which include the attached solar collectors 58 and battery assemblies 106, are positioned facedown on the panel sheet at the proper location to align the sensor bars 32 with the sensor bar apertures 128. The panel sheet with the bottom panel 140 is placed in the injection cavity over the sheet of top panel 120 and the flex board assemblies. The cavity is covered with a pressure plate and the remaining space between the panel sheets is shot with a fast curing polymer that fills all voids and creates an integral card panel. The discrete cards are die cut from the card panel and sent to testing. Loading of the software, particularly the security software, is preferably done prior to the flex board assemblies being placed into the injection cavity and injected with polymer. The injection process provides added security by eliminating tampering, as an attempt to physically access the internal regions of the card will result in destruction of the card.

Because of the high pressure and high velocity of the polymer injection process, certain precautions are taken to maintain the integrity of the internal components. The chipsets, particularly the processor 86 and the wafer sensor chip 88, are ground or fabricated to required thickness and polished to improve durability and flexibility. The chips are bonded to the flex board 114 and connections to the etched or printed circuits on the flex board 114 are made by thin gold hopper wires 142 that jump directly from the chip terminals 144 to terminal pads 146 on the flex board 114, as shown in FIG. 5. The series of hopper wires add a structural stability to the interconnection of chip and board when the polymer filler is added.

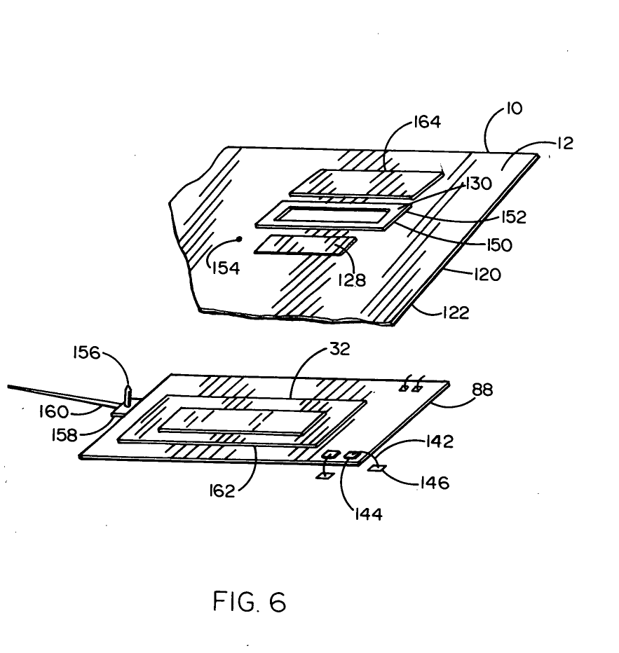

Additionally, because the high pressure injection process has a potential to leak through the aperture 128 between the top panel 120 and sensor bar 32, precautions are taken as shown in FIG. 6. In the enlarged partial detail of FIG. 6, the aperture 128 for the sensor bar 30 has the conductive metal foil frame 130 coated on its underside 150 with a conductive mastic 152 that adheres to the top surface 12 of the card 10 and covers a hole 154 adjacent the sensor aperture 128 for the finger swipe bar 32. The hole 154 aligns with a grounding pin 156 that projects from a grounding pad 158 on the flex board 114. The grounding pad 158 connects with a ground line 160 that is part of the power control circuit 104. A mastic bead or ring 162 encompasses the sensor bar 32 and seats the sensor chip 88 against the underside 122 of the top panel 120 of the card 10 with the sensor bar 30 in the aperture 128 and the pin 156 in the hole 154 in contact with the conductive mastic 152 on the underside 150 of the foil frame 130 on assembly. Before the polymer injection, a plug 164 having a thickness designed to locate the top of the sensor bar 32 below the top surface 12 of the top panel 120 is inserted in the aperture 128. This locates the sensor bar and assists in maintaining the seal during injection of the polymer.

It is to be understood that other sealing systems may be employed around the perimeter of the sensor bar 32. For example, a sealant that migrates under force of the injection may be used as the ring 162. By selecting a sealant that has strong self-adherence and limited adherence to the sensor bar 32, the plug 164 can be omitted and the sealant allowed to flow across the surface of the sensor bar 32. Before use and initialization of the card by the ultimate user, the sealant is rubbed off the surface of the sensor bar. In this manner, the sealant provides some protection to the sensor bar after fabrication and before use.

Referring to the alternate embodiment 170 of FIG. 7, the biometric card 10 has a differently configured flex board assembly 172 shown on bottom panel 140 as previously described. The alternate card 170 has a top panel (not shown) that is similarly prepared with an appropriate cutout for the vertically oriented sensor bar 174 and windows for the thin film, high-resolution display 38 and LED status light 176. The LED status light 176 is an added I/O control 24 that indicates that the card 170 is awake and processing.

The flex board assembly 172 has a flex board 178 that carries an integrated systems chip or ASIC 180, which incorporates the sensor bar 174 into a chip having the processor, memory, power regulator and other higher level operational components consolidated and integrated for system security and lowered cost. The flex board 178 is therefore primarily a docking and routing platform for the auxiliary components, including the high-resolution display 38, the RF energy harvester 66, a thin film battery 182 and an RF transmitter and signal-processing chip 184.

The high resolution display 38 is preferably a thin-film, organic light-emitting diode (OLED) display 186, that is a specialty LED that can be fabricated using inexpensive printing technologies. The OLED display 186 has an integral driver 188 and a thin, flexible terminal flag 190 that is anchored to the flex board 178 by contact welds 192 that connect the driver circuitry to the routing circuitry (not shown) printed on the flex board 178. The OLED display 186 is a monochromatic pixel display that can display six characters 194 in large, bold type and can be programmed to display other alphanumeric characters and graphic icons as desired to facilitate the ease of operating the card, or simply, to amuse.

Similarly, the RF energy harvester 66 is constructed with a printed, thin film antenna 196 having a flexible terminal flag 198 anchored to the flex board 178 by terminal welds 200. The thin film battery 182 has a flexible flag 202 anchored to the underside of the flex board 178 by terminal welds 204 (shown in dotted line). The RF transmitter and signal processing chip 184 is directly mounted on the surface of the flex board and includes the circuit electronics to extract electrical energy from the RF antenna 198 and when prompted to emit an RF signal representing the transaction PIN or code generated by the ASIC 180. The ASIC 180 is bonded to the flex board 178 and includes hopper wires 206 connecting terminals on the top of the chip to terminal pads 208 on the flex board 178.

The activation switch 210 is shown in part as a printed contact 211 that cooperates with a cooperating conductor pad on the overlay panel as previously described.

The low-profile LED status light 176 is bonded to the flex board 178 in contact with the circuitry for timely operation when the system is awakened by the activation switch 210.

Overall, the system operates as previously described with the additional feature of a local RF broadcast of the transaction PIN or code together with the account information for use by a local transaction processing receiver in advanced transaction processing stations having RF capabilities. In typical transaction processing stations, the magnetic strip and card swipe will provide necessary account data and the transaction PIN or code is entered manually or is orally provided by the user to the person processing the transaction.

The status light 176 has an extremely low power draw and conserves the stored power so that the relatively high power draw of the display can be limited. It is intended that in both embodiments disclosed, the processor and timing circuitry is shut down during the extended periods of non-use to prevent power drain. This is possible in the preferred systems not using a real time clock. When restarted, the status light 176 provides a convenient low power alert to the user that the system is up-and-running. The display 36, particularly the more energy consuming OLED display 186, is timed to sleep after a brief period and must be awakened by depressing the activation switch 210 to display the last transaction PIN or code. This feature is needed, for example, by a restaurant merchant who may be holding the card until a bill is cleared. The status light 176 assures that the longer period before system shutdown has not occurred and that the card is operating and will quickly respond to a prompt, and re-display the last transaction PIN or code.

Additionally, since a start-up from a full shutdown may take several seconds, the status light prompts the user when a finger swipe can be attempted.

A long life OLED display is traditionally fabricated by mating microparticle deposits on glass which are sandwiched and sealed. Although flexible polymer film is also being used, current polymer displays have limited life. To resolve problems with excessively thick and rigid glass displays, the fabrication system schematically illustrated in FIG. 8 is used.

Referring to FIG. 8, a thin glass top sheet 212 is coupled to a thicker glass carrier sheet 214 and held in place by Vanderwal forces. The composite thickness is sized for conventional deposit equipment when fabricating displays of conventional thickness. The thin glass top sheet 212 faces a thin glass bottom sheet 216, which is also coupled to a thicker glass carrier sheet 218 and held in place by similar means.

The thin glass sheets 212 and 216 are, for example, manufactured by Corning Glass under a product line code 0211 for a thickness range of 0.0020 to 0.025 inches. The thin glass sheets 212 and 216 are prepared in a conventional manner with discrete deposits 220 on the mating faces 222 and 226 before coupling and sealing.

The coupled sheets are cut into display size modules and separated from the carrier segments for subsequent completion of the display fabrication process.

The thin glass displays are relatively flexible and damage resistant when incorporated on the flex board assembly 172 and floated between the card panels before shooting the cards with a cushioning polymer filler. The described process permits the preferred glass displays to be sufficiently thin to maintain the desired card profile that simulates a common credit card or debit card.

While, in the foregoing, embodiments of the present invention have been set forth in considerable detail for the purposes of making a complete disclosure of the invention, it may be apparent to those of skill in the art that numerous changes may be made in such detail without departing from the spirit and principles of the invention. Accordingly, the scope of the invention hereof is to be deemed limited only by the appended claims and their equivalents with the words thereof being understood to having their ordinary meanings as one of ordinary skill in the relevant arts would understand them.

We claim:

1. A biometric authentication card having the size and shape substantially that of a common credit card and comprising:
an exposed surface having a multi-digit data display and a biometric sensor that permits access by an authorized user to verify such authorization by generation of a biometric seed number and display of a transaction discrete personal identification number (PIN);
a plurality of adhered panel sheets having at least one thin film battery, a thin film power generator, a power regulator and an electronic circuit having a processor for conducting calculations to generate said seed number and said transaction discrete PIN, said panel sheets being joined together in sealing engagement to form said card as an integral monolithic structure.

2. A method of fabricating a biometric authentication card having the size and shape substantially that of a common credit card, the method comprising the steps of:
providing a front panel sheet having windows for exposing a data display and a biometric sensor and having relevant indicia relating to the purpose of the card;
preparing at least one inner panel sheet having components comprising at least one of the set including a processor, a power source and said display, and said sensor thereon, as well as interconnecting electric circuits;
providing a bottom panel sheet for protecting said components; and
inserting a curable compound between said front panel sheet and said bottom panel sheet for sealing said components and forming an integral monolithic discrete card.

3. A biometric authentication card, being a product of the process described in claim 2.
